(19) United States
(12) Patent Application Publication
(10) Pub. No.: US 2011/0054056 A1
(43) Pub. Date: Mar. 3, 2011

(54) THERMOSET POLYURETHANES

(76) Inventors: Robert E. Hefner, JR., Lake Jackson, TX (US); James W. Ringer, Midland, MI (US)

(21) Appl. No.: 12/989,480

(22) PCT Filed: May 4, 2009
(86) PCT No.: PCT/US09/42644

§ 371 Date: Oct. 25, 2010

Related U.S. Application Data
(60) Provisional application No. 61/055,235, filed on May 22, 2008.

(51) Int. Cl. C08G 18/00; C08G 18/32; C08L 75/04

(52) U.S. Cl. 521/155; 528/79; 528/68; 524/590

(57) ABSTRACT

Thermoset polyurethanes comprising a cis, trans-1,3- and -1,4-cyclohexanedimethylether moiety. Adducts of epoxy resins comprising a cis, trans-1,3- and -1,4-cyclohexanedimethylether moiety are used to react with a polyisocyanate to produce the thermoset polyurethanes.

### BACKGROUND OF THE INVENTION

1. Field of the Invention

The present invention relates to thermoset polyurethanes comprising a cis, trans-1,3- and -1,4-cyclohexanedimethylether moiety.

2. Description of Background and Related Art

Conventional thermoset polyurethanes and their preparation have been described in various references, for example, in Polyurethane Handbook, published by Macmillan Publishing Co., Inc. (1985); in Polyurethanes: Chemistry and Technology, Part I, Chemistry, High Polymers, volume XVI, pages 32-61, published by Interscience Publishers (1965); and in Flexible Urethane Foams Chemistry and Technology, pages 27-43, published by Applied Science Publishers (1982).

It is also known in the art to use 1,4-cyclohexanedimethanol as a component in forming polyurethane products. For example, U.S. Pat. No. 4,167,612 teaches the use of 1,4-cyclohexanedimethanol as a low molecular weight crosslinking agent for making flexible polyurethane foams. U.S. Pat. No. 6,734,273 teaches thermoplastic polyurethanes made from polyols having a high secondary hydroxyl content and using 1,4-cyclohexanedimethanol as a chain extender. WO/1997/011980 teaches the use of 1,4-cyclohexanedimethanol as a diol chain extender for rigid thermoplastic polyurethanes. D. J. Lyman, in Polyurethanes. II. Effect of cis-trans isomerism on properties of polyurethanes, Journal of Polymer Science, volume 55, issue 162, pages 507-514 (Mar. 10, 2003) describes polyurethanes made from cis and trans 1,4-cyclohexanedimethanol and methylene bis(4-phenyl isocyanate).

However, there is no disclosure nor suggestion in the prior art that teaches a thermoset polyurethane comprising a cis, trans-1,3- and -1,4-cyclohexanedimethylether moiety.

The 1,4-cyclohexanedimethanol used as a component in forming the polyurethanes disclosed in the prior art is difunctional with respect to the polyurethane forming reaction and thus has limited ability to enhance physical and mechanical properties of thermoset polyurethane products. The 1,4-cyclohexanedimethanol cannot provide the crosslinking performance that a polyfunctional molecule, such as cis, trans-1,3- and -1,4-cyclohexanedimethylether moiety, is capable of providing. Difunctional molecules can only provide linear chain extension. Crosslinking, which causes thermosetting, is directly responsible for enhancement of many properties, for example, increased glass transition temperature, increased thermal resistance, increased flexural modulus (stiffness/rigidity), and/or increased hardness. It can also affect moisture resistance (increased hydrolytic stability) and resistance to certain types of corrosive media (e.g. acids, bases) and organic solvents.

Therefore, it would be highly beneficial to have a cis, trans-1,3- and -1,4-cyclohexanedimethanol composition that is polyfunctional with respect to the polyurethane forming reaction for use as a component providing the highly desirable cyclohexyl moiety along with crosslinking of the polyurethane matrix.

### SUMMARY OF THE INVENTION

The present invention uses adducts of epoxy resins comprising a cis, trans-1,3- and -1,4-cyclohexanedimethylether moiety to react with a polyisocyanate to produce thermoset polyurethanes.

One aspect of the present invention is directed to a polyurethane composition comprising (a) an adduct and (b) a polyisocyanate, wherein the adduct comprises at least one cis, trans-1,3- and -1,4-cyclohexanedimethylether moiety and has more than two Zerewitinoff active hydrogen atoms per molecule.

Another aspect of the present invention is directed to a thermoset polyurethane comprising at least one cis, trans-1,3- and -1,4-cyclohexanedimethylether moiety.

A further aspect of the present invention is directed to an article comprising a thermoset polyurethane, wherein the thermoset polyurethane comprises at least one cis, trans-1,3- and -1,4-cyclohexanedimethylether moiety.

### DETAILED DESCRIPTION OF THE INVENTION

In the following detailed description, the specific embodiments of the present invention are described in connection with its preferred embodiments. However, to the extent that the following description is specific to a particular embodiment or a particular use of the present techniques, it is intended to be illustrative only and merely provides a concise description of the exemplary embodiments. Accordingly, the present invention is not limited to the specific embodiments described below, but rather; the present invention includes all alternatives, modifications, and equivalents falling within the true scope of the appended claims.

Unless otherwise stated, a reference to a material, a compound, or a component includes the material, compound, or component by itself, as well as in combination with other materials, compounds, or components, such as mixtures or combinations of compounds.

As used herein, the singular forms “a,” “an,” and “the” include the plural reference unless the context clearly dictates otherwise.

As noted above, the thermoset polyurethane of the present invention comprises at least one cis, trans-1,3- and -1,4-cyclohexanedimethylether moiety. The thermoset polyurethane is produced from a polyurethane composition, which comprises (a) an adduct and (b) a polyisocyanate, wherein the adduct comprising a cis, trans-1,3- and -1,4-cyclohexanedimethylether moiety and has more than two Zerewitinoff active hydrogen atoms per molecule.

According to the present invention, the polyurethane composition of the present invention may comprises at least one adduct comprising a cis, trans-1,3- and -1,4-cyclohexanedimethylether moiety.

As used herein, the term “adduct” means a product of a direct addition of two or more distinct molecules, resulting in a single reaction product. The resultant reaction product or adduct is considered a distinct molecular species from the reactants.

The term “cis, trans-1,3- and -1,4-cyclohexanedimethylether moiety” used herein means a structure or a blend of chemical structures comprising four geometric isomers, a cis-1,3-cyclohexanedimethylether, a trans-1,3-cyclohexanedimethylether structure, a cis-1,4-cyclohexanedimethylether, and a trans-1,4-cyclohexanedimethylether, within an epoxy resin. The four geometric isomers are shown in the followings structures:

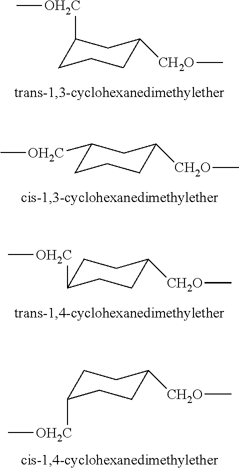

The adduct of the present invention comprises at least one reaction product of an epoxy resin material (A) and a reactive compound (B), wherein the epoxy resin material (A) comprises a cis, trans-1,3- and -1,4-cyclohexanedimethylether moiety, and wherein the reactive compound (B) comprises a compound having two or more reactive hydrogen atoms per molecule, and the reactive hydrogen atoms are reactive with epoxide groups.

Preferably, the epoxy resin material (A), comprising a cis, trans-1,3- and -1,4-cyclohexanedimethylether moiety, may comprise one of the following epoxy resins:

(1) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol (also referred to as diglycidyl ethers of cis, trans-1,3- and 1,4-cyclohexanedimethanol);

(2) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, and one or more oligomers thereof;

(3) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, and a monoglycidyl ether of trans-1,4-cyclohexanedimethanol; or

(4) an epoxy resin comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexanedimethanol, a monoglycidyl ether of cis-1,3-cyclohexanedimethanol, a monoglycidyl ether of trans-1,3-cyclohexanedimethanol, a monoglycidyl ether of cis-1,4-cyclohexanedimethanol, a monoglycidyl ether of trans-1,4-cyclohexanedimethanol, and one or more oligomers thereof.

The epoxy resins (3) and (4) above may comprise a controlled amount of the monoglycidyl ether of cis-1,3-cyclohexanedimethanol, monoglycidyl ether of trans-1,3-cyclohexanedimethanol, monoglycidyl ether of cis-1,4-cyclohexanedimethanol, and monoglycidyl ether of trans-1,4-cyclohexanedimethanol (also referred to as monodiglycidyl ethers of cis, trans-1,3- and 1,4-cyclohexanedimethanol). For example, the amount of the monoglycidyl ethers may be in the range of from about 0.1 percent to about 90 percent by weight; preferably, from about 0.1 percent to about 20 percent by weight; and more preferably, from about 0.1 percent to about 10 percent by weight based on the total weight of the epoxy resin material (A).

A detailed description of the above epoxy resins comprising the cis, trans-1,3- and -1,4-cyclohexanedimethylether moiety and the processes for preparing the same is provided in co-pending U.S. patent application Ser. No. ______ (Attorney Docket No. 64833), incorporated herein by reference.

It has been discovered, as disclosed in a co-pending U.S. patent application Ser. Nos. ______ and ______ (Attorney Docket Nos. 64833 and 64916, respectively), incorporated herein by reference, that epoxy resins or adducts of the epoxy resins comprising a cis, trans-1,3- and -1,4-cyclohexanedimethylether moiety have improved properties such as no crystallization at room temperature and lower viscosity compared to epoxy resins or adducts of the epoxy resins comprising a cis, trans-1,4-cyclohexanedimethylether moiety alone. These improved properties increase the ability of the epoxy resins, or the adducts of the epoxy resins, to accept higher solid contents. In addition, some epoxy resins or adducts of the epoxy resins comprising the cis, trans-1,3- and -1,4-cyclohexanedimethylether moiety as disclosed in the above co-pending patent applications have very low chloride (including ionic, hydrolyzable and total chloride) content and high diglycidyl ether content, which provide the epoxy resins or the adducts of the epoxy resins with increased reactivity toward conventional epoxy resin curing agents, reduced potential corrosivity, and improved electrical properties. Some adducts of the epoxy resins comprising the cis, trans-1,3- and -1,4-cyclohexanedimethylether moiety are capable to provide higher reactivity, improved compatibility, and improved glass transition temperature profile when employed as curing agents for epoxy resins compared to the adducts of the epoxy resins comprising the cis, trans-1,4-cyclohexanedimethylether moiety alone.

The reactive compound (B) used to react with the epoxy resin material (A) to form the adduct useful in the present invention comprises at least one compound having two or more reactive hydrogen atoms per molecule. The reactive hydrogen atoms are reactive with epoxide groups, such as those epoxide groups contained in the epoxy resin material (A). The term “reactive hydrogen atom” as used herein means that the hydrogen atom is reactive with an epoxide group.

Examples of the reactive compound (B) may include compounds such as (a) di- and polyphenols, (b) di- and polycarboxylic acids, (c) di- and polymercaptans, (d) di- and polyamines, (e) primary monoamines, (f) sulfonamides, (g) aminophenols, (h) aminocarboxylic acids, (i) phenolic hydroxyl containing carboxylic acids, (j) sulfanilamides, and (k) any combination of any two or more of such compounds or the like.

A detailed description of the adducts comprising the cis, trans-1,3- and -1,4-cyclohexanedimethylether moiety and the processes for preparing the same is provided in co-pending U.S. patent application Ser. No. ______ (Attorney Docket No. 64916), incorporated herein by reference.

According to the present invention, the polyurethane composition may further comprises at least one organic material (Z) having more than two Zerewitinoff active hydrogen atoms per molecule. The organic material (Z) is different from the above adduct used to form the polyurethane composition of the present invention.

The organic material (Z) generally comprises more than two Zerewitinoff active hydrogen atoms and at least one isocyanate reactive functional group, wherein the Zerewitinoff active hydrogen atoms are attached to the isocyanate reactive functional groups. Examples of the isocyanate reactive functional groups may include —OH, —SH, —COOH, or —NHR, wherein R is hydrogen or an alkyl moiety.

Examples of the organic material (Z) may include polyols, preferably diols. Other examples such as polyamines, alkanolamines, or polysulfhydryl containing compounds may also be used, either in place of or in addition to the polyols.

More specific examples of the organic material (Z) may include polyether polyols; amine capped polyether polyols; hydroxyl containing polyesters; aliphatic hydroxyl containing polycarbonates; hydroxyl containing polythioethers; hydroxyl containing polyolefins; hydroxyl containing urethanes and ureas prepared by the reaction of, for example, a diisocyanate and a stoichiometric excess of a diol, or by the reaction of a diisocyanate and a stoichiometric excess of a diamine; hydroxyl and/or amino containing polyesteramides; amino containing polyamides; alkanolamines; aliphatic, cycloaliphatic, polycycloaliphatic diols and polyols; polyamines; mercaptoalcohols; mercaptoamines; polymer modified polyols, i.e., containing vinyl polymer or copolymer grafted polyol, vinyl polymer or copolymer and unreacted polyol; polyols containing dispersed polyurea particles, i.e., polyharnstoff dispersion polyols; and any mixture thereof.

Other examples of the organic material (Z) may be found in the aforementioned Polyurethane Handbook, pages 42-60; in Polyurethanes: Chemistry and Technology, Part I, Chemistry, High Polymers, volume XVI, pages 32-61, published by Interscience Publishers (1965); and in Flexible Urethane Foams Chemistry and Technology, pages 27-43, published by Applied Science Publishers (1982), all of which are incorporated herein by reference.

More preferred examples of the organic material (Z) may include polyether polyols having average molecular weights of from about 250 g/mol to about 6000 g/mol and having from about 2 g/mol to about 8 g/mol hydroxyl groups per molecule; or blends of these polyether polyols with chain extenders such as those discussed below.

Organic material (Z) may also comprise a chain extender, for example, organic diols or glycols having a total of from 2 to about 20 carbon atoms such as alkane diols, aromatic diols, alkylaromatic diols, cycloaliphatic diols, polycycloaliphatic diols, and any combination thereof; and glycols such as dialkylene ether glycols, aromatic glycols, and any combination thereof.

Examples of suitable alkane diols useful as a chain extender may have a total of from about 2 to about 6 carbon atoms, and may include, for example, 1,2-ethanediol, 1,6-hexanediol, 1,3-butanediol, 1,5-pentanediol, 1,4-butanediol and mixtures thereof.

Examples of suitable alkylaromatic diols useful as a chain extender may include 1,4-bis(2-hydroxyethoxy)benzene, 1,4-dimethylol benzene, and mixtures thereof.

Examples of suitable cycloaliphatic glycols useful as a chain extender may include 1,3- or 1,4-cyclohexanedimethanol; norbornane dimethanol; 1,3 or 1,4-cyclohexanediol; and mixtures thereof.

Examples of suitable polycycloaliphatic diols useful as a chain extender may include dicyclopentadiene dimethanol, polycyclopentadiene dimethanol and mixtures thereof.

Examples of suitable dialkylene ether glycols useful as a chain extender may include diethylene glycol, dipropylene glycol and mixtures thereof.

Examples of suitable aromatic glycols useful as a chain extender may include 1,4-benzenedimethylol, toluenedimethylol and mixtures thereof.

Aromatic amines such as, for example, 3,3′-dichloro-4,4′-diaminodiphenyl methane or 4,4′-methylene-bis(3-chloro-2,6-diethylaniline) may also serve as chain extenders. Mixtures of the one or more chain extenders can also be employed in the present invention.

An effective amount of the chain extender may serve to increase the molecular weight of the polyurethane. In general, the effective amount of the chain extender may be within the range of from about 1 percent to about 50 percent by weight; preferably, from about 2 percent to about 25 percent by weight; and more preferably, from about 3 percent to about 15 percent by weight based on the total weight of the adduct and the organic material (Z).

According to the present invention, the ratio of the adduct and the organic material (Z) may be in the range of from about 1 percent to about 99 percent by weight of the adduct and from about 99 percent to about 1 percent by weight of the organic material (Z); preferably, in the range of from about 10 percent to about 75 percent by weight of the adduct and from about 90 percent to about 25 percent by weight of the organic material (Z); and more preferably, in the range of from about 10 percent to about 50 percent by weight of the adduct and from about 90 percent to about 50 percent by weight of the organic material (Z).

It is within the scope of the present invention that the polyurethane composition may optionally comprise one or more monofunctional reactants, which have one isocyanate reactive functional group per molecule. The isocyanate reactive functional group per molecule may be —OH, —SH, —COOH, or —NHR, wherein R is hydrogen or an alkyl moiety.

Examples of the monofunctional reactants may include monols, monosulfhydryl containing compounds, monocarboxylic acids, and primary or secondary monoamines.

The monofunctional reactants may be used in an effective amount in order to obtain polyurethane products with desired properties, for example, a desired amount of chains in the forming polyurethane matrix to control molecular weight, handling, or mechanical properties.

Generally, the effective amount of monofunctional reactants, if used, may be within the range of from about 0.1 percent to about 25 percent by weight; preferably, from about 0.1 percent to about 10 percent by weight; and more preferably, from about 0.1 percent to about 5 percent by weight of the adduct and organic material (Z).

Any polyisocyanate may be used to prepare the polyurethane composition of the present invention. Examples of suitable polyisocyanates may be those polyisocyanates comprising an average of more than one isocyanate group per molecule, e.g. diisocyanates.

More specific examples of the polyisocyanates which are suitable for the present invention include aliphatic, cycloaliphatic, polycycloaliphatic, aryl substituted aliphatic, aromatic, or heterocyclic polyisocyanates, and any prepolymers and oligomers thereof.

Representative of the polyisocyanates may include, for example, 1,6-hexamethylene diisocyanate; 1,4-cyclohexane diisocyanate; 1,3-cyclohexane diisocyanate; 2,4-hexahydrotoluene diisocyanate; 2,6-hexahydrotoluene diisocyanate; perhydro-4,4′-diisocyanatodiphenyl methane; perhydro-2,4′-diisocyanatodiphenyl methane; perhydro-2,2′-diisocyanatodiphenyl methane; perhydro-3,3′-dimethyl-4,4′-diphenyldiisocyanate; 2,4-toluene diisocyanate; 2,6-toluene diisocyanate; 4,4′-diisocyanatodiphenyl methane; 2,4′-diisocyanatodiphenyl diisocyanate; 2,2′-diisocyanatodiphenyl methane; 2,4′-diisocyanatodiphenyl methane; polyphenyl polymethylene polyisocyanates; naphthalene-1,5-diisocyanate; 4,4′-diisocyanatotrimethyl cyclohexane; polyphenylene polymethylene polyisocyanate; 4,4′-diisocyanatobiphenyl; 3,3′-dimethyl-4,4′-diisocyanatodiphenyl; 3,3′,5,5′-tetramethyl-4,4′-diisocyanatodiphenyl; 2,2′,6,6′-tetramethyl-4,4′-diisocyanatodiphenyl; 4,4′-diisocyanatostilbene; 4,4′-diisocyanatodiphenylacetylene; 4,4′-diisocyanatoazobenzene; 4,4′-diisocyanatoazoxybenzene; 4,4′-bis((4-isocyanato)phenoxy)diphenyl; 4,4-diisocyanatobenzanilide; 4′-isocyanatophenyl-4-isocyanatobenzoate; 4,4′-diisocyanato-alpha-methylstilbene; 4,4′-diisocyanato-alpha-cyanostilbene; 4,4′-diisocyanato-alpha-ethylstilbene; 4,4′-diisocyanatodiphenylazomethine; isophorone diisocyanate; and any mixture thereof.

Details about the polyisocyanates and their preparation are described, for example, in Encyclopedia of Chemical Technology, third edition, volume 13, pages 789-818, published by John Wiley and Sons (1981), and by Siefken in Justus Leibegs Annalen der Chemie, 562, pages 75-136, both of which are incorporated herein by reference.

Additional polyisocyanates which are useful to prepare the polyurethane compositions of the present invention may include a polyisocyanate containing urethane group, a polyisocyanate containing carbodiimide group, a polyisocyanate containing allophanate group, a polyisocyanate containing isocyanurate group, a polyisocyanate containing urea group, a polyisocyanate containing biuret group, a polyisocyanate containing acylated urea group, a polyisocyanate containing ester group, and any mixture thereof.

Examples of the polyisocyanates containing urethane groups may include, for example, reaction products of toluene diisocyanate and trimethylolpropane as described in Polyurethane Handbook, pages 77-79, published by Macmillan Publishing Co., Inc. (1985) or the polyisocyanates described in U.S. Pat. No. 3,394,164; both of which are incorporated herein by reference.

Examples of the polyisocyanates containing carbodiimide groups may include, for example, those described in U.S. Pat. No. 3,152,162 and by Ozaki in Chemical Reviews, 72, pp. 486-558 (1972); both of which are incorporated herein by reference.

Examples of the polyisocyanates containing allophanate groups may include, for example, those described in British Patent No. 994,890, Belgian Patent No. 761,626 and in the aforementioned Polyurethane Handbook reference, page 81; all of which are incorporated herein by reference;

Examples of the polyisocyanates containing isocyanurate groups may include, for example, those described in U.S. Pat. Nos. 3,001,973 and 3,154,522; German Patents Nos. 1,002,789; 1,027,394 and 1,222,067; and in the aforementioned Polyurethane Handbook reference, pages 79-80; all of which are incorporated herein by reference.

Examples of the polyisocyanates containing urea groups may include, for example, those described in the aforementioned Polyurethane Handbook reference, pages 81-82, which is incorporated herein by reference.

Examples of the polyisocyanates containing biuret groups may include, for example, those described in U.S. Pat. Nos. 3,124,605 and 3,201,372; British Patent No. 889,050; and in the aforementioned Polyurethane Handbook reference, page 82; all of which are incorporated herein by reference;

Examples of the polyisocyanates containing acylated urea groups may include, for example, those described in German Patent No. 1,230,778, which is incorporated herein by reference.

Examples of the polyisocyanates containing ester groups may include, for example, those described in U.S. Pat. No. 3,567,763; British Patent Nos. 965,474 and 1,072,956; and German Patent No. 1,231,688; all of which are incorporated herein by reference.

Commercially available polyisocyanates may also be used in the present invention and may include toluene diisocyanates, diisocyanatodiphenyl methanes, polyphenyl polymethylene polyisocyanates, isophorone diisocyanates, hexamethylene diisocyanates, hydrogenated diisocyanatodiphenylmethanes, and any mixtures or any isomeric mixtures thereof.

As stated above, the adduct of the present invention comprises at least one reaction product of an epoxy resin material (A) and a reactive compound (B). The epoxy resin material (A) comprises a cis, trans-1,3- and -1,4-cyclohexanedimethylether moiety. The reaction may be a ring opening reaction between the epoxy resin material (A) and the reactive compound (B).

The adduct of the present invention may also comprise at least four isocyanate hydrogen atoms per molecule. Two of these isocyanate reactive hydrogen atoms may be from secondary hydroxyl groups generated from ring opening reaction of the reactive compound (B) with the epoxy resin material (A). The remaining two or more isocyanate reactive hydrogen atoms may be unreacted isocyanate reactive hydrogen atoms present in the reactive compound (B). The ratio of the adduct and the polyisocyanate in the polyurethane composition is generally from about 1:0.90 to about 1.0:1.25, preferably from about 0.95:1.0 to about 1.1:1.0 equivalents of the isocyanate group present in the polyisocyanate per equivalent of isocyanate reactive hydrogen atom per molecule present in the adduct.

The polyurethane composition of the present invention may also comprise one or more catalysts. Catalysts conventionally employed or known in the art to catalyze the reaction of an isocyanate with a reactive hydrogen atom containing compound can be employed for this purpose.

Such catalysts may include, for example, organic and inorganic acid salts of, and organometallic derivatives of, bismuth, tin, iron, antimony, cobalt, thorium, aluminum, zinc, nickel, cerium, molybdenum, vanadium, copper, manganese and zirconium, as well as phosphines and tertiary organic amines; and mixtures thereof.

Representative organometallic derivatives of tin catalysts may include stannous octoate, dibutyltin dioctoate, dibutyltin diluarate, and any combination thereof.

Representative tertiary organic amine catalysts may include triethylamine, triethylenediamine, N,N,N′N′-tetramethylethylenediamine, N,N,N′N′-tetraethylethylenediamine, N-methylmorpholine, N-ethylmorpholine, N,N,N′,N′-tetramethylguanidine, N,N,N′,N′-tetramethyl-1,3-butanediamine, N,N-dimethylethanolamine, N,N-diethylethanolamine, and any combination thereof. Preferred catalysts useful in the present invention include, for example, stannous octoate, dibutyltin dioctoate, dibutyltin diluarate, and any combination thereof.

The amount of catalyst employed in the present invention is generally within the range of from about 20 parts to about 500 parts by weight per million parts of the total weight of the polyurethane composition. A minimum amount of catalyst may be used to minimize side reactions.

Thermoset polyurethanes of the present invention comprise a product of a reaction of the adduct and the polyisocyanate, and optionally, the organic material (Z).

The reaction may be performed in stages or increments or as a one-step process. Suitable reaction conditions, reaction times, reaction temperatures, and optional catalysts for preparation of the thermoset polyurethane compositions of the present invention are well known to those skilled in the art and are described in the aforementioned Polyurethanes: Chemistry and Technology reference, pages 129-217, and in the aforementioned Encyclopedia of Chemical Technology reference, pages 576-608; both of which are incorporated herein by reference.

In a preferred process of the present invention, the adduct and any organic material (Z) is reacted with a stoichiometric excess of polyisocyanate to form an isocyanate terminated prepolymer. A preferred ratio of the polyisocyanate to the adduct and any organic material (Z) is from about 2:1 to about 20:1, and more preferably from about 2.5:1 to about 8:1 moles of isocyanate groups present in the polyisocyanate to per mole of isocyanate reactive hydrogen atoms present in the adduct.

When one or more of organic material (Z) is incorporated into this prepolymer it is preferably combined with the adduct prior to the reaction with the polyisocyanate. The resultant product is an isocyanate terminated prepolymer containing excess polyisocyanate which can be used as a material having more than one isocyanate group per molecule for using in subsequent polyurethane forming reaction.

In another embodiment of the present invention, the adduct, alone or mixed with another isocyanate reactive compound, organic material (Z), is reacted with substantially less than a stoichiometric amount of one or more polyisocyanates to form a prepolymer terminated by active hydrogen groups such as hydroxyl groups. A preferred ratio of the polyisocyanate to the adduct is from about 0.05:1 to about 0.60:1, and more preferably from about 0.20:1 to about 0.50:1 moles of isocyanate groups present in the polyisocyanate per mole of isocyanate reactive hydrogen atoms present in the adduct.

The prepolymer product contains isocyanate reactive hydrogen atoms and, as such, can then be reacted with a material having more than one isocyanate group per molecule to form a polyurethane product. Alternately, the prepolymer can be reacted with a stoichiometric excess of a polyisocyanate as previously described to form another prepolymer, which in this case is isocyanate terminated.

Other process configurations can be used to prepare the thermoset polyurethane of the present invention and will be readily apparent to the skilled artisan.

The thermoset polyurethanes of the present invention may be cellular (foam) or non-cellular and may additionally comprise one or more additives including, for example, fillers, pigments, dyes, mold release agents, reinforcing materials, and any mixture thereof.

The thermoset polyurethanes of the present invention are useful in the preparation of castings, moldings, coatings, structural foams, flexible foams, rigid foams, insulation, and the like.

Polyisocyanurate foams represent a special class of rigid foams which may be prepared using the adduct of the present invention. Polyisocyanurate foams are generally prepared by the catalytic trimerization of a polyisocyanate such as those previously delineated herein and the adduct of the present invention.

The polyisocyanurate foam composition of the present invention comprises (1) the adduct of the present invention; (2) the organic material (Z) as described above, wherein the organic material (Z) may comprise, for example, one or more polyols; (3) a surfactant such as a silicone surfactant; and (4) a blowing agent, and the like. The polyisocyanurate foam produced from the polyisocyanurate foam composition may comprise a polyisocyanurate-polyurethane structure or a polyisocyanurate-polyurethane-polyurea structure.

A trimerization catalyst may be employed to promote the polyisocyanurate foam formation. Such catalysts include, for example, those taught by U.S. Patent Publication No. 2007/0259983 A1 (Nov. 8, 2007) which is incorporated herein by reference in its entirety. A monocarboxylate catalyst is preferred.

Representative of the trimerization catalysts may include those commercially available from Air Products, Inc. including for example DABCO TMR™, a 75% solution of 2-hydroxypropyltrimethylammonium octoate in ethylene glycol; and DABCO K15™, a 70% solution of potassium 2-ethylhexanoate in diethylene glycol.

The trimerization catalyst is generally employed an amount which provides trimerization of isocyanate groups, ranging from about 0.1 percent to about 5.0 percent by weight of polyisocyanate present in the polyisocyanurate foam composition.

The amount of the blowing agent may be chosen based on desired foam properties, for example, density and stiffness. Generally, an amount ranging from about 1 percent to about 30 percent by weight based on the weight of the polyisocyanate present in the polyisocyanurate foam composition may be used.

The blowing agents may be organic liquids with boiling points below about 100° C. Examples of the blowing agents include aliphatic, cycloaliphatic and aromatic hydrocarbons; non-fluorinated halogenated or partially halogenated aliphatic hydrocarbons; partially halogenated aliphatic hydrocarbons where the halogen can include fluorine; and mixtures thereof. Chlorofluorocarbons had been used in the past as blowing agents but are not used in the present due to environmental concerns.

Representative examples of blowing agents useful for the present invention may include n-pentane, iso-pentane, n-hexane, heptane, 1-pentene, 2-pentene, 2-methylbutene, 3-methylbutene, 1-hexene, cyclohexane cyclopentane, cyclohexene, cyclopentene, n-propyl chloride, n-propyl bromide, n-propyl fluoride, dichloromethane, ethylene bromide, methylene bromide, chloroform, carbon tetrachloride, ethylene dichloride, and any mixtures thereof.

The following Examples and Comparative Experiments further illustrate the present invention in detail but are not to be construed to limit the scope thereof.

### Examples

### Example 1

### A. Lewis Acid Catalyzed Coupling of Epichlorohydrin and cis, trans-1,3- and 1,4-Cyclohexanedimethanol (CHDM) using Tin (IV) Chloride Followed by Epoxidation

A 3 liter, 5 neck, glass, round bottom, Morton reactor was charged under nitrogen with CHDM (865.26 grams, 6.00 moles, 12.0 hydroxyl equivalents). The CHDM used was a commercial grade product, UNOXOL™ Diol, manufactured and marketed by The Dow Chemical Company. Gas chromatographic (GC) analysis of the CHDM revealed the presence of 99.5 area % (22.3, 32.3, 19.6, and 25.3 area % for 4 individual isomers) with the 0.5 area % balance comprising a single minor impurity. The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). Epichlorohydrin (1313.9 grams, 14.2 moles) was added to a side arm vented addition funnel, then attached to the reactor. Stirring commenced concurrent with heating using a thermostatically controlled heating mantle. Once the stirred CHDM reached 50° C., tin (IV) chloride (4.69 grams, 0.018 mole) was added to the reactor. Once the temperature equilibrated at 50° C. the first aliquot of epichlorohydrin (106.1 grams, 8.07 weight % of total epichlorohydrin) was added dropwise over 38 minutes. The reaction temperature was observed for the next 6 minutes and controlled to 50° C. by cycling between heating and cooling via a cooling fan on the reactor exterior. Dropwise addition of the remaining epichlorohydrin (1207.8 grams) commenced and was completed over 259 minutes while maintaining the temperature at 50° C. One hour after completion of the epichlorohydrin addition, an aliquot of the coupling product was analyzed via GC revealing 0.16 area % epichlorohydrin, no unreacted CHDM, 5.86 area % CHDM monochlorohydrin (all 4 isomers observed), 65.48 area % CHDM dichlorohydrin (all 4 isomers observed), and 28.23 area % oligomer precursors. At this time, deionized (DI) water (820 milliliters) and methylisobutylketone (566 grams) were added to the stirred reactor.

Heating to 70° C. commenced and dropwise addition of a solution of sodium hydroxide (528 grams, 13.2 moles) in DI water (528 grams) was commenced and then was completed over the next 181 minutes while maintaining the temperature at 70° C. Two hours after completion of the aqueous sodium hydroxide addition, an aliquot of the epoxidation product was analyzed via GC revealing no unreacted CHDM, 3.93 area % CHDM monoglycidyl ether (all 4 isomers observed), 52.97 area % CHDM diglycidyl ether (all 4 isomers observed) and 42.17 area % oligomers. At this time additional DI water (446 milliliters) was added to the reactor followed by shutting off stirring and pouring the reactor contents into a pair of separatory funnels. The aqueous layer was resolved and discarded to waste. The remaining organic layers were each washed with fresh DI water (400 milliliters). The recovered organic layer was added back into the reactor followed by reheating to 70° C. and addition of a solution of sodium hydroxide (80 grams, 2.0 moles) in DI water (160 grams). Two hours after addition of the aqueous sodium hydroxide, stirring was shut off and the reactor contents poured into a pair of separatory funnels. The aqueous layer was resolved and discarded to waste. The remaining organic layers were each washed with fresh DI water (400 milliliters). The recovered organic layer was added back into the reactor followed by a repeat of the aforementioned treatment with aqueous sodium hydroxide. After an additional final wash with fresh DI water (800 milliters), rotary evaporation was completed at a 70° C. maximum oil bath temperature to remove the bulk of the volatiles followed by holding at 110° C. and a vacuum of 0.5 mm Hg for 4 hours to provide 1702.18 grams of colorless liquid. The resultant product was vacuum filtered through a pad of diatomaceous earth packed in a medium fritted glass funnel. GC analysis revealed the presence of 0.06 area % CHDM (all 4 isomers observed), 4.19 area % CHDM monoglycidyl ether (all 4 isomers observed), 58.73 area % CHDM diglycidyl ether (all 4 isomers observed) and 36.79 area % oligomers. Titration of an aliquot of the product demonstrated 27.42% epoxide (156.93 epoxide equivalent weight). Viscosity of an aliquot of the product at 25° C. was determined on an I.C.I. Cone and Plate Viscometer. The 4 individual measurements gave a viscosity of 66.25, 66.25, 66.25 and 65 centipoise for an average of 66 centipoise. An aliquot of the crude product obtained from the rotary evaporation was analyzed for ionic, hydrolyzable and total chlorides giving the following results: Hydrolyzable Cl=none detected, Ionic Cl=none detected, Total Cl=3.52%.

### B. Preparation and Characterization of an Adduct of n-Butylamine and Epoxy Resin of cis, trans-1,3- and 1,4-Cyclohexanedimethanol

A 2 liter, 3 neck, glass, round bottom, reactor was charged under nitrogen with n-butylamine (877.7 grams, 12 moles, 24 amine hydrogen equivalents). The n-butylamine used was a commercial grade product obtained from Aldrich Chemical Company with a purity specification of 99.5%. The reactor was additionally equipped with a condenser (maintained at 0° C.), a thermometer, a Claisen adaptor, an overhead nitrogen inlet (1 LPM N₂ used), and a stirrer assembly (Teflon™ paddle, glass shaft, variable speed motor). A portion (156.9 gram, 1.0 epoxide equivalent) of the epoxy resin of CHDM from Part A. above was added to a side arm vented addition funnel, then attached to the reactor. Stirring and heating using a thermostatically controlled heating mantle commenced to give a 40° C. solution. Dropwise addition of the epoxy resin of CHDM commenced while maintaining the 40° C. reaction temperature. After 7.4 hours, the dropwise addition was completed. The stirred, transparent, colorless solution was maintained at 40° C. for the next 61.5 hours followed by rotary evaporation to remove the bulk of the excess n-butylamine. Finishing the rotary evaporation at an oil bath temperature of 110° C. for 2 hours provided an adduct product (104.08 grams) as a transparent, pale yellow colored liquid. GC analysis of an aliquot of the adduct product revealed that complete reaction of the epoxy resin of CHDM had occurred. Titration of aliquots of the adduct product demonstrated an average amine hydrogen equivalent weight of 275.29. Titration for hydroxyl equivalent weight was not performed. A calculated hydroxyl equivalent weight of 231.1 was used based on the theoretical structure and isolated yield of the adduct product.

### C. Preparation of a Polyurethane Foam using n-Butylamine Adduct of the Epoxy Resin of cis, trans-1,3- and -1,4-Cyclohexanedimethanol Without Index Adjustment

Polymethylene polyphenylisocyanate (PAPI™ 580N, The Dow Chemical Company) with an isocyanate equivalent weight of 137 (400 parts) and a blended product containing polyol, N,N-dimethylbenzylamine catalyst, triethylphosphate flame retardant, and water as a blowing agent (Voracor™ CD 897, The Dow Chemical Company) with a hydroxyl number of 287 to 384 milligrams per gram as KOH (ASTM D-4274) (220 parts) and the n-butylamine adduct of the epoxy resin of cis, trans-1,3- and -1,4-cyclohexanedimethanol (31 parts) from Part B above were used to prepare a rigid foam.

The foam preparation was accomplished via the following method: The polyol plus adduct formulation and the polyisocyanate formulation were each well-mixed and equilibrated to 73° F. A 12 inch by 12 inch by 6 inch tall cardboard box was prepared prior to foaming. When both polyol plus adduct and polyisocyanate formulations were equilibrated at 73° F., the polyol plus adduct formulation was added to the polyisocyanate formulation, mixing of the system with a high speed air driven mixer is initiated and continued for 10 seconds. After 10 seconds of mixing, the system was quickly poured into the cardboard box to allow foam growth. The reactivity of the foam was determined by observing cream and firm times. Cream and firm times were started when the mixing blades begin touching the chemicals. The cream time was recorded when the mixture began to change color, generally just before the rise. The firm time was the time when the foam achieved a hard inner core. The foam product was allowed to sit for 7 days prior to physical property testing. Test pieces for the testing of K-factor, density, and cell size were cut from the finished foam product. K-factor was determined via standard test method ASTM C-518 using a 75° F. mean temperature. Density was determined via standard test method ASTM D-1622 with a pair of separate samples evaluated. Analysis of cell size was completed using scanning electron microscopy (SEM) with a pair of separate samples evaluated. Results of the testing are reported in Table I.

### Example 2

### Preparation of a Polyurethane Foam using n-Butylamine Adduct of the Epoxy Resin of cis, trans-1,3- and -1,4-Cyclohexanedimethanol with Index Adjustment

Polymethylene polyphenylisocyanate (PAPI™ 580N, The Dow Chemical Company) with an isocyanate equivalent weight of 137 (459.43 parts) and a blended product containing polyol, N,N-dimethylbenzylamine catalyst, triethylphosphate flame retardant, and water as a blowing agent (Voracor™ CD 897, The Dow Chemical Company) with a hydroxyl number of 287 to384 milligrams per gram as KOH (ASTM D-4274) (220 parts) and the n-butylamine adduct of the epoxy resin of cis, trans-1,3- and -1,4-cyclohexanedimethanol (31 parts) from Part B. above were used to prepare a rigid foam using the method of Example 1 Part C. Results of the testing are reported in Table I.

### Comparative Experiment A—Preparation of a Standard Polyurethane Foam

Polymethylene polyphenylisocyanate (PAPI™ 580N, The Dow Chemical Company) with an isocyanate equivalent weight of 137 (400 parts) and a blended product containing polyol, N,N-dimethylbenzylamine catalyst, triethylphosphate flame retardant, and water as a blowing agent (Voracor™ CD 897 from The Dow Chemical Company) with a hydroxyl number of 287 to384 milligrams per gram as KOH (ASTM D 4274) (220 parts) were used to prepare a rigid foam using the method of Example 1 Part C. Results of the testing are reported in Table I.

TABLE I

| Sample | Cream Time¹ | Firm Time | Density | | Cell size |
|---|---|---|---|---|---|
| Designation | (seconds) | (seconds) | (pcf) | k-factor | (mm) |
| Example 1 | 30 | 95 | 1.90 +/− 0.07 | 0.1949 | 0.54 +/− 0.1 |
| Part C | | | | | |
| Example 2 | 30 | 98 | 2.12 +/− 0.10 | 0.1906 | 0.55 +/− 0.1 |
| Comparative | 30 | 90 | 1.79 +/− 0.06 | 0.1967 | 0.57 +/− 0.0 |
| Experiment | | | | | |
| A | | | | | |

¹Individually the PAPI 580N and Voracor CD 897 possess relatively low viscosity (approximately 800 cPs at 73° F.). Conversely, the adduct is relatively high in viscosity. In Comparative Experiment A, during the mixing of only the PAPI 580N and Voracor CD 897 the viscosity of the mixture is immediately much higher than the viscosity of the independent components. Unexpectedly, in Example 1 Part C. and Example 2, the addition of the adduct produced no observable change in viscosity during mixing over that of the mixing of the PAPI 580N and Voracor CD 897 alone of Comparative Experiment A.

### Example 3

### A. Characterization of Epoxy Resin of cis, trans-1,3- and -1,4-Cyclohexanedimethanol with Oligomeric Components from Lewis Acid Catalyzed Coupling and Epoxidation Process

GC analysis of an epoxy resin of cis, trans-1,3- and -1,4-cyclohexanedimethanol with oligomeric components from a Lewis acid catalyzed coupling and epoxidation process revealed 0.12 area % cis, trans-1,3- and -1,4-cyclohexanedimethanol, 7.88 area % cis, trans-1,3- and -1,4-cyclohexanedimethanol monoglycidyl ether (2.91, 1.41, 2.61, and 0.95 area % for the 4 individual isomers), 50.48 area % cis, trans-1,3- and -1,4-cyclohexanedimethanol diglycidyl ether (10.07, 18.16, 5.35, and 16.90 area % for the 4 individual isomers), 40.60 area % oligomers, with the balance as minor impurities. Titration of an aliquot of the epoxy resin demonstrated 25.71% epoxide (167.39 EEW).

### B. Preparation and Characterization of an Adduct of Ammonia and Epoxy Resin of cis, trans-1,3- and -1,4-Cyclohexanedimethanol with Oligomeric Components from Lewis Acid Catalyzed Coupling and Epoxidation Process

A 5 liter, 3 neck, glass, round bottom, reactor was charged with ammonium hydroxide (1474.6 grams, approximately 75 amine hydrogen equivalents) and isopropanol (1474.6 grams). The ammonium hydroxide used was a commercial grade product obtained from Aldrich Chemical Company with a purity specification of 28 to 30 as % NH₃. The reactor was additionally equipped with a condenser (maintained at 0° C.), a thermometer, a Claisen adaptor, and a stirrer assembly (teflon paddle, glass shaft, variable speed motor) (the reaction was run under air, not under nitrogen). A portion (167.39 g, 1.00 epoxide equivalent) of epoxy resin of cis, trans-1,3- and -1,4-cyclohexanedimethanol with oligomeric components from Part A. above was added to a side arm vented addition funnel, then attached to the reactor. Stirring and heating using a thermostatically controlled heating mantle commenced to give a 35° C. solution. Dropwise addition of the epoxy resin of cis, trans-1,3- and -1,4-cyclohexanedimethanol with oligomeric components commenced while maintaining the 35° C. reaction temperature. After 17.5 hours, the dropwise addition was completed. The stirred, colorless, transparent solution was maintained at 35° C. for the next 22.6 hours followed by filtration through a medium fritted glass funnel then rotary evaporation to remove the bulk of the excess ammonium hydroxide. Finishing the rotary evaporation at 110° C. and 0.4 mm Hg for 2 hours provided the adduct product (182.6 grams) as a transparent, colorless, highly viscous liquid. GC analysis of an aliquot of the adduct product revealed that complete reaction of the diglycidyl ether (and the minor amount of monoglycidyl ether) had occurred. Titration of aliquots of the adduct product demonstrated an average amine hydrogen equivalent weight of 258.3. Titration for hydroxyl equivalent weight was not performed. Hydroxyl equivalent weight was calculated to be 292.74.

### C. Preparation of a Thermoset Polyurethane using the Adduct of Ammonia and Epoxy Resin of cis, trans-1,3- and -1,4-Cyclohexanedimethanol with Oligomeric Components from Lewis Acid Catalyzed Coupling and Epoxidation Process

### Preparation of Hydroxyl and Amine Functional Reactant Solution

A 16 ounce glass bottle which had been predried in an oven at 100° C. for >48 hours was used for the polyurethane synthesis. The predried bottle was removed from the oven, placed on a scale with 4 decimal place accuracy, charged with poly(ethylene glycol) (10.3792 grams, 0.00453 hydroxyl equivalent) and ammonia adduct of epoxy resin of cis, trans-1,3- and -1,4-cyclohexanedimethanol with oligomeric components (0.0646 gram, 0.00025 amine hydrogen equivalent plus 0.00022 hydroxyl equivalent calculated) from Part B. above then blanketed with nitrogen and sealed with a cap followed by a tape seal made with electrical tape. The poly(ethylene glycol) was obtained as a commercial grade product from Sigma-Aldrich Chemical Co. Moisture analysis by Karl Fischer titration revealed 0.10 percent water. Gel permeation chromatographic (GPC) analysis gave Mn=4583. Viscosity was 169.2 centistokes at 210° F. The sealed bottle was then introduced into the dry nitrogen glovebox. The glovebox was continuously maintained at <0.20 ppm oxygen, <1 ppm water, and 20° C. Once inside the glove box, the bottle was unsealed, placed on a scale with 2 decimal place accuracy, then charged with anhydrous N,N-dimethylformamide (50.01 grams) and sealed as previously described. The anhydrous N,N-dimethylformamide, 99.8%, was obtained from Sigma-Aldrich Chemical Co. The Sure Seal™ 1 L bottles were sparged on a Schlenk line with dry nitrogen before introduction into the glovebox. Once in the glovebox, anhydrous molecular sieves (Davidson Type 4 A, grade 514) which had been dried at 150° C. under a vacuum of 0.6 mm Hg for 52 hours were added to the N,N-dimethylformamide bottles. The N,N-dimethylformamide was held in the glovebox over molecular sieves >48 hours before use. Once sealed, the bottle was removed from the glovebox.

### Analysis of Trace Water in Hydroxy and Amine Functional Reactant Solution

For the determination of water, the sealed bottle was placed in an oven maintained at 70° C. and periodically removed and shaken until a solution formed. A sample (1.0908 grams) was removed from the bottle using a preweighed, disposable polypropylene syringe, and titrated for water on the Karl Fischer apparatus (Mettler Toledo DL39 Karl Fischer Coulometer). The titration apparatus was first standardized via titration of a 0.0044 gram sample of DI water. Recovery of 98.70% was achieved (acceptable recovery for the DI water standard using this equipment and method is 90 to 110%). A weighing of samples was performed on an analytical balance to 4 decimal places. The sample (1.0629 grams) injected into the Karl Fischer titrator analyzed at 855.32 ppm (0.085532 percent weight) of water. A sampling correction factor (0.98196) was calculated by dividing the weight of the hydroxyl and amine functional reactant solution into the weight of this solution subtraction of the weight of the sample removed for Karl Fischer titration.

### Reaction with Toluene Diisocyanate to Form Polyurethane Solution

The toluene diisocyanate used was obtained as a commercial grade product, VORNATE™ T-80 Type I TDI (The Dow Chemical Company). This product nominally contains 79-81% of the 2,4-isomer and 19-21% of the 2,6-isomer and an assay of 99.5 wt % toluene diisocyanate minimum. A sample of the toluene diisocyanate was added under a dry nitrogen atmosphere (glovebox) to anhydrous methanol. After 4 hours a portion of the solution was added to acetonitrile for high pressure liquid chromatographic (HPLC) analysis. The bis(methyl carbamate)s formed from reaction of methanol and the toluene diisocyanate were detected at 3.38 and 3.81 minutes at 14.58 and 84.15 area %, respectively. Several minor components were additionally detected comprising 0.09, 0.20, 0.41, and 0.58 area % (it is not known if these minor components result from minor impurities in the toluene diisocyanate or as side products from the aforementioned reaction of the toluene diisocyanate and methanol).

For reaction with toluene diisocyanate, the sealed bottle was placed in an oven maintained at 70° C. and periodically removed and shaken until a solution re-formed. Once a solution had formed, the bottle was allowed to equilibrate for 1 hour. The bottle was then removed from the oven, unsealed, a nitrogen blanket maintained over the contents, and dibutyltin dilaurate catalyst (0.0022 gram, 200 ppm) preweighed on a scale with 4 decimal place accuracy was added from a capillary dropper. The bottle was then sealed and vigorously shaken. Next the bottle was placed on a scale with 2 decimal place accuracy in a vented hood behind a secondary explosion proof shield (this shielded the scale from airflow thus minimizing deviation in weighing), unsealed, and a nitrogen blanket maintained over the contents. Immediately before weighing, the nitrogen purge was shut off and the scale re-zeroed. Toluene diisocyanate (0.92 gram, 0.01057 isocyanate equivalent) was weighed into the bottle. The nitrogen purge immediately resumed to displace air from the bottle which was then sealed and vigorously shaken behind the explosion proof shield. The cap was opened to release any pressure, followed by re-blanketing with nitrogen and again sealing and shaking. The cap was again opened followed by re-blanketing with nitrogen, sealing, shaking and placing into the 70° C. oven for the next 6 hours. The bottle was periodically shaken several times during the 6 hours of reaction in the oven.

### Calculation for Toluene Diisocyanate Reactant

The toluene diisocyanate required for reaction with hydroxyl and amine hydrogen was calculated by multiplying the correction factor, 0.98196, times the total hydroxyl and amine hydrogen equivalents provided by the poly(ethylene glycol) and the amine adduct, 0.0050, times 87.069 grams per isocyanate equivalent in toluene diisocyanate, giving 0.4275 gram. The toluene diisocyanate required for reaction with the titrated trace water in the hydroxyl and amine functional reactant solution was calculated by subtraction of the weight of the sample removed for Karl Fischer titration from the original weight of the hydroxyl and amine functional reactant solution to provide the net weight of said solution. The percent weight water from the titration divided by 100 was then multiplied by the net weight of the reactant solution to give the amount of water present (0.050775 gram). Dividing by the molecular weight of water provides the mole of water present (0.002818 mole). The water in mole is multiplied by 2, since the well known reaction of the isocyanate moiety with water to form poly(urea) consumes 2 equivalents of isocyanate per equivalent of water. Multiplication by the isocyanate equivalent weight of toluene diisocyanate (87.069 grams per equivalent) yields 0.4908 gram of toluene diisocyanate required for reaction of water in the reactant solution. Thus, the total toluene diisocyanate needed was 0.9183 gram.

### Calculation for Dibutyltin Dilaurate Catalyst

The dibutyltin dilaurate catalyst employed was calculated by multiplying the correction factor, 0.98196, times the collective weight of the poly(ethylene glycol) (10.3792 grams) plus amine adduct (0.0646 gram) then adding the total weight of toluene diisocyanate used (0.92 gram), giving the net weight of reactants (11.1588 grams). Multiplying the net weight of the reactants by 0.0002 provided the weight of dibutyltin dilaurate (0.0022 gram) needed to achieve 200 ppm.

### Isolation of Polyurethane Product

The light yellow colored, transparent liquid product solution was transferred into a 0.5 liter single neck round bottom flask using N,N-dimethylformamide to wash all product from the jar. Rotary evaporation was completed using a 75° C. oil bath temperature to remove the bulk of the N,N-dimethylformamide solvent (2.75 hours) followed by rotary evaporation at 125° C. to a final vacuum of 0.49 mm Hg (0.92 hour). The product (10.98 grams) solidified to a light yellow colored rigid solid at room temperature (˜25° C.

### D. Characterization of a Thermoset Polyurethane Elastomer Prepared using the Adduct of Ammonia and Epoxy Resin of cis, trans-1,3- and -1,4-Cyclohexanedimethanol with Oligomeric Components from Lewis Acid Catalyzed Coupling and Epoxidation Process

Differential scanning calorimetry was conducted using a DSC 2910 Modulated DSC (TA Instruments) with a heating rate of 7° C. per minute from −60° C. to 200° C. followed by cooling from 200° C. per minute to −60° C. under a stream of nitrogen flowing at 45 cubic centimeters per minute. The DSC analysis was completed using 20.50 and 24.80 milligram portions of the polyurethane from Part C. above. The results are summarized in Table II.

### Example 4

### A. Preparation of a Thermoset Polyurethane using an Increased Amount of the Adduct of Ammonia and Epoxy Resin of cis, trans-1,3- and -1,4-Cyclohexanedimethanol with Oligomeric Components from Lewis Acid Catalyzed Coupling and Epoxidation Process

### Preparation of Hydroxyl and Amine Functional Reactant Solution

A 16 ounce glass bottle which had been predried in an oven at 100° C. for >48 hours was used for the polyurethane synthesis. The predried bottle was removed from the oven, placed on a scale with 4 decimal place accuracy, charged with poly(ethylene glycol) (9.3008 grams, 0.0040588 hydroxyl equivalent) and ammonia adduct of epoxy resin of cis, trans-1,3- and -1,4-cyclohexanedimethanol with oligomeric components (0.1292 gram, 0.00050 amine hydrogen equivalent plus 0.00044 hydroxyl equivalent calculated) from Example 3 Part B. then blanketed with nitrogen and sealed with a cap followed by a tape seal made with electrical tape. The poly(ethylene glycol) used is described in Example 3 Part C. The sealed bottle was then introduced into the dry nitrogen glovebox. The glovebox was continuously maintained at <0.20 ppm oxygen, <1 ppm water, and 20° C. Once inside the glove box, the bottle was unsealed, placed on a scale with 2 decimal place accuracy, then charged with anhydrous N,N-dimethylformamide (50.17 grams) and sealed as previously described. The anhydrous N,N-dimethylformamide is described in Example 3 Part C. Once sealed, the bottle was removed from the glovebox.

### Analysis of Trace Water in Hydroxy and Amine Functional Reactant Solution

For the determination of water, the sealed bottle was placed in an oven maintained at 70° C. and periodically removed and shaken until a solution formed. A sample (1.0651 grams) was removed from the bottle using a preweighed, disposable polypropylene syringe, and titrated for water on the Karl Fischer apparatus (Mettler Toledo DL39 Karl Fischer Coulometer). The titration apparatus was first standardized via titration of a 0.0044 g sample of DI water. Recovery of 98.70% was achieved (acceptable recovery for the DI water standard using this equipment and method is 90 to 110%). A weighing of samples was performed on an analytical balance to 4 decimal places. The sample (1.0345 grams) injected into the Karl Fischer titrator analyzed at 918.58 ppm (0.091858 percent weight) of water. A sampling correction factor (0.98213) was calculated by dividing the weight of the hydroxyl and amine functional reactant solution into the weight of this solution subtraction of the weight of the sample removed for Karl Fischer titration.

### Reaction with Toluene Diisocyanate to Form Polyurethane Solution

The toluene diisocyanate used is described in Example 3 Part C. For reaction with toluene diisocyanate, the sealed bottle was placed in an oven maintained at 70° C. and periodically removed and shaken until a solution re-formed. Once a solution had formed, the bottle was allowed to equilibrate for 1 hour. The bottle was then removed from the oven, unsealed, a nitrogen blanket maintained over the contents, and dibutyltin dilaurate catalyst (0.0020 gram, 200 ppm) preweighed on a scale with 4 decimal place accuracy was added from a capillary dropper. The bottle was then sealed and vigorously shaken. Next the bottle was placed on a scale with 2 decimal place accuracy in a vented hood behind a secondary explosion proof shield (this shielded the scale from airflow thus minimizing deviation in weighing), unsealed, and a nitrogen blanket maintained over the contents. Immediately before weighing, the nitrogen purge was shut off and the scale re-zeroed. Toluene diisocyanate (0.95 gram, 0.01091 isocyanate equivalent) was weighed into the bottle. The nitrogen purge immediately resumed to displace air from the bottle which was then sealed and vigorously shaken behind the explosion proof shield. The cap was opened to release any pressure, followed by re-blanketing with nitrogen and again sealing and shaking. The cap was again opened followed by re-blanketing with nitrogen, sealing, shaking and placing into the 70° C. oven for the next 6 hours. The bottle was periodically shaken several times during the 6 hours of reaction in the oven.

### Calculation for Toluene Diisocyanate Reactant

The toluene diisocyanate required for reaction with hydroxyl and amine hydrogen was calculated by multiplying the correction factor, 0.98213, times the total hydroxyl and amine hydrogen equivalents provided by the poly(ethylene glycol) and the amine adduct, 0.0050, times 87.069 grams per isocyanate equivalent in toluene diisocyanate, giving 0.4276 gram. The toluene diisocyanate required for reaction with the titrated trace water in the hydroxyl and amine functional reactant solution was calculated by subtraction of the weight of the sample removed for Karl Fischer titration from the original weight of the hydroxyl and amine functional reactant solution to provide the net weight of said solution. The percent weight water from the titration divided by 100 was then multiplied by the net weight of the reactant solution to give the amount of water present (0.053768 gram). Dividing by the molecular weight of water provides the mole of water present (0.0029845 mole). The water in mole is multiplied by 2, since the well known reaction of the isocyanate moiety with water to form poly(urea) consumes 2 equivalents of isocyanate per equivalent of water. Multiplication by the isocyanate equivalent weight of toluene diisocyanate (87.069 grams per equivalent) yields 0.5197 gram of toluene diisocyanate required for reaction of water in the reactant solution. Thus, the total toluene diisocyanate needed was 0.9473 gram.

### Calculation for Dibutyltin Dilaurate Catalyst

The dibutyltin dilaurate catalyst employed was calculated by multiplying the correction factor, 0.98213, times the collective weight of the poly(ethylene glycol) (9.3008 grams) plus amine adduct (0.1292 gram) then adding the total weight of toluene diisocyanate used (0.95 gram), giving the net weight of reactants (10.3800 grams). Multiplying the net weight of the reactants by 0.0002 provided the weight of dibutyltin dilaurate (0.0020 gram) needed to achieve 200 ppm.

### Isolation of Polyurethane Product

The light yellow colored, transparent liquid product solution was transferred into a 0.5 liter single neck round bottom flask using N,N-dimethylformamide to wash all product from the jar. Rotary evaporation was completed using a 75° C. oil bath temperature to remove the bulk of the N,N-dimethylformamide solvent (2.17 hours) followed by rotary evaporation at 125° C. to a final vacuum of 0.49 mm Hg (0.7 hour). The product (10.06 grams) solidified to a light yellow colored rigid solid at room temperature.

### B. Characterization of a Thermoset Polyurethane Prepared using the Adduct of Ammonia and Epoxy Resin of cis, trans-1,3- and -1,4-Cyclohexanedimethanol with Oligomeric Components from Lewis Acid Catalyzed Coupling and Epoxidation Process

Differential scanning calorimetry was conducted using a DSC 2910 Modulated DSC (TA Instruments) with a heating rate of 7° C. per minute from −60° C. to 200° C. followed by cooling from 200° C. per minute to −60° C. under a stream of nitrogen flowing at 45 cubic centimeters per minute. The DSC analysis was completed using 21.60 and 23.00 milligram portions of the polyurethane from Part A. above. The results are summarized in Table II.

### Comparative Experiment B

### A. Preparation of a Thermoset Polyurethane Standard Preparation of Hydroxyl Functional Reactant Solution

A 16 ounce glass bottle which had been predried in an oven at 100° C. for >48 hours was used for the polyurethane synthesis. The predried bottle was removed from the oven, placed on a scale with 4 decimal place accuracy, charged with poly(ethylene glycol) (11.4600 grams, 0.0050 hydroxyl equivalent) then blanketed with nitrogen and sealed with a cap followed by a tape seal made with electrical tape. The poly(ethylene glycol) used is described in Example 3 Part C. The sealed bottle was then introduced into the dry nitrogen glovebox. The glovebox was continuously maintained at <0.20 ppm oxygen, <1 ppm water, and 20° C. Once inside the glove box, the bottle was unsealed, placed on a scale with 2 decimal place accuracy, then charged with anhydrous N,N-dimethylformamide (50.02 grams) and sealed as previously described. The anhydrous N,N-dimethylformamide is described in Example 3 Part C. Once sealed, the bottle was removed from the glovebox.

### Analysis of Trace Water in Hydroxy and Amine Functional Reactant Solution

For the determination of water, the sealed bottle was placed in an oven maintained at 70° C. and periodically removed and shaken until a solution formed. A sample (2.2387 grams) was removed from the bottle using a preweighed, disposable polypropylene syringe, and titrated for water on the Karl Fischer apparatus (Mettler Toledo DL39 Karl Fischer Coulometer). The titration apparatus was first standardized via titration of a 0.0044 gram sample of DI water. Recovery of 98.70% was achieved (acceptable recovery for the DI water standard using this equipment and method is 90 to 110%). A weighing of samples was performed on an analytical balance to 4 decimal places. The sample (1.0888 grams) injected into the Karl Fischer titrator analyzed at 903.33 ppm (0.090333 percent weight) of water. A sampling correction factor (0.96359) was calculated by dividing the weight of the hydroxyl functional reactant solution into the weight of this solution subtraction of the weight of the sample removed for Karl Fischer titration.

### Reaction with Toluene Diisocyanate to Form Polyurethane Solution

The toluene diisocyanate used is described in Example 3 Part C. For reaction with toluene diisocyanate, the sealed bottle was placed in an oven maintained at 70° C. and periodically removed and shaken until a solution re-formed. Once a solution had formed, the bottle was allowed to equilibrate for 1 hour. The bottle was then removed from the oven, unsealed, a nitrogen blanket maintained over the contents, and dibutyltin dilaurate catalyst (0.0024 gram, 200 ppm) preweighed on a scale with 4 decimal place accuracy was added from a capillary dropper. The bottle was then sealed and vigorously shaken. Next the bottle was placed on a scale with 2 decimal place accuracy in a vented hood behind a secondary explosion proof shield (this shielded the scale from airflow thus minimizing deviation in weighing), unsealed, and a nitrogen blanket maintained over the contents. Immediately before weighing, the nitrogen purge was shut off and the scale re-zeroed. Toluene diisocyanate (0.94 gram, 0.010796 isocyanate equivalent) was weighed into the bottle. The nitrogen purge immediately resumed to displace air from the bottle which was then sealed and vigorously shaken behind the explosion proof shield. The cap was opened to release any pressure, followed by re-blanketing with nitrogen and again sealing and shaking. The cap was again opened followed by re-blanketing with nitrogen, sealing, shaking and placing into the 70° C. oven for the next 6 hours. The bottle was periodically shaken several times during the 6 hours of reaction in the oven.

### Calculation for Toluene Diisocyanate Reactant

The toluene diisocyanate required for reaction with hydroxyl hydrogen was calculated by multiplying the correction factor, 0.96359, times the total hydroxyl hydrogen equivalents provided by the poly(ethylene glycol), 0.0050, times 87.069 grams per isocyanate equivalent in toluene diisocyanate, giving 0.4195 gram. The toluene diisocyanate required for reaction with the titrated trace water in the hydroxyl and amine functional reactant solution was calculated by subtraction of the weight of the sample removed for Karl Fischer titration from the original weight of the hydroxyl and amine functional reactant solution to provide the net weight of said solution. The percent weight water from the titration divided by 100 was then multiplied by the net weight of the reactant solution to give the amount of water present (0.0535144 gram). Dividing by the molecular weight of water provides the mole of water present (0.0029704 mole). The water in mole is multiplied by 2, since the well known reaction of the isocyanate moiety with water to form poly(urea) consumes 2 equivalents of isocyanate per equivalent of water. Multiplication by the isocyanate equivalent weight of toluene diisocyanate (87.069 grams per equivalent) yields 0.5173 gram of toluene diisocyanate required for reaction of water in the reactant solution. Thus, the total toluene diisocyanate needed was 0.9368 gram.

### Calculation for Dibutyltin Dilaurate Catalyst

The dibutyltin dilaurate catalyst employed was calculated by multiplying the correction factor, 0.96359, times the weight of the poly(ethylene glycol) (11.4600 grams) then adding the total weight of toluene diisocyanate used (0.94 gram), giving the net weight of reactants (11.9827 grams). Multiplying the net weight of the reactants by 0.0002 provided the weight of dibutyltin dilaurate (0.0024 gram) needed to achieve 200 ppm.

### Isolation of Polyurethane Product

The light yellow colored, transparent liquid product solution was transferred into a 0.5 liter single neck round bottom flask using N,N-dimethylformamide to wash all product from the jar. Rotary evaporation was completed using a 75° C. oil bath temperature to remove the bulk of the N,N-dimethylformamide solvent (2.1 hours) followed by rotary evaporation at 125° C. to a final vacuum of 0.36 mm Hg (1.43 hours). The product (11.69 grams) solidified to a light yellow colored rigid solid at room temperature.

### B. Characterization of a Thermoset Polyurethane Standard

Differential scanning calorimetry was conducted using a DSC 2910 Modulated DSC (TA Instruments) with a heating rate of 7° C. per minute from −60° C. to 200° C. followed by cooling from 200° C. per minute to −60° C. under a stream of nitrogen flowing at 45 cubic centimeters per minute. The DSC analysis was completed using 19.80 and 19.10 milligram portions of the polyurethane from Part A. above. The results are summarized in Table II.

TABLE II
Results from Differential Scanning Calorimetry
Analysis of Polyurethanes

| | Maximum | | Maximum | Enthalpy |
|---|---|---|---|---|
| | Endotherm | Enthalpy | Exotherm | Crystal- |
| Sample | upon Heating | Melting | upon Cooling | lization |
| Designation | ° C. | joules/g | ° C. | joules/g |
| Example 3D. | 57.4 | 82.4 | 21.7 | 80.4 |
| Example 4B. | 59.4 | 3.4 | 13.4 | 62.4 |
| Comparative | 56.6 | 6.3 | 25.7 | 94.3 |
| Experiment | | | | |

### Example 5

### Gel Permeation Chromatographic (GPC) Analysis of the Polyurethane Prepared using the Adduct of Ammonia and Epoxy Resin of cis, trans-1,3- and -1,4-Cyclohexanedimethanol with Oligomeric Components from Lewis Acid Catalyzed Coupling and Epoxidation Process

A Polymer Labs Mixed B series of 3 columns maintained at 50° C. were along with a differential refractometer detector (Waters 410) to conduct GPC analysis. N,N-dimethylformamide was used as an eluent at a flow rate of 1 mL per min. The injection volume was 100 microliters. The samples were diluted in N,N-dimethylformamide to a concentration of 0.23-0.28%. Calibration was performed using Polymer Laboratories Polyethylene Glycol Calibrants, PEG 10 [poly(ethylene glycol)] and PEO-10 [poly(ethylene oxide)]. Relative standard deviations for Mₙ, M_{w}, and M_{w}/Mₙ were less than 1.5%; for, Mₚ less than 6.5%; and for M_{z} and M_{z+1} less than 5%. The units for each of the aforementioned measurements, except polydispersity (M_{w}/Mₙ), are in grams per mole.

Portions of the polyurethanes from Example 3 Part C and Example 4 Part A were added to tetrahydrofuran but found to be insoluble. A sample of the polyurethane from Example 3 Part C was dissolved in N,N-dimethylformamide at 80° C., while the polyurethane from Example 4 Part A was found to be insoluble in N,N-dimethylformamide at 80° C. GPC analysis of the polyurethane of Example 3 Part C gave the following results: Mₙ=35500, M_{w}=123000, M_{w}/Mₙ=3.45, Mₚ=64000, M_{z}=385000, M_{z+1}=780000.

### Comparative Experiment C—GPC Analysis of Polyurethane Standard

A portion of the polyurethane from Comparative Experiment B was added to tetrahydrofuran but found to be insoluble. A sample of the polyurethane from Comparative Experiment B was dissolved in N,N-dimethylformamide at 80° C. GPC analysis of the polyurethane of gave the following results: Mₙ=21200, M_{w}=72000, M_{w}/Mₙ=3.38, Mₚ=32900, M_{z}=219000, M_{z+1}=440000.

1. A polyurethane composition comprising (a) an adduct and (b) a polyisocyanate, wherein the adduct comprises at least one cis, trans-1,3- and -1,4-cyclohexanedimethylether moiety and has more than two Zerewitinoff active hydrogen atoms per molecule.

2. The composition according to claim 1 further comprising at least one organic material (Z) having more than two Zerewitinoff active hydrogen atoms per molecule, and wherein the material (Z) is different from the adduct.

3. The composition according to claim 2, wherein the organic material (Z) comprises more than two Zerewitinoff active hydrogen atoms and at least one isocyanate reactive functional groups; wherein the organic material (Z) comprises a polyol;
wherein the organic material (Z) further comprises a polyamine containing compound, an alkanolamine containing compound, a polysulfhydryl containing compound, or any combination thereof; wherein the organic material (Z) comprises a polyether polyol having average molecular weights of from about 250 to about 6000 and having from about 2 to about 8 hydroxyl groups per molecule; and/or wherein the organic material (Z) comprises a polyether polyol having average molecular weights of from about 250 to about 6000 and having from about 2 to about 8 hydroxyl groups per molecule blended with a chain extender.

4. The composition according to claim 3, wherein the isocyanate reactive functional group comprises —OH, —SH, —COOH, or —NHR, with R being hydrogen or an alkyl moiety.

5. The composition according to claim 3, wherein the polyol is a diol.

6. The composition according to claim 2, wherein the organic material (Z) further comprises a chain extender; and wherein the chain extender comprises a diol or a glycol having a total of from 2 to about 20 carbon atoms.

7. The composition according to claim 6, wherein the chain extender comprises an alkane diol, an aromatic diol, an alkylaromatic diol, a cycloaliphatic diol, a polycycloaliphatic diol, or any combination thereof; or wherein the chain extender comprises a dialkylene ether glycol, an aromatic glycol, or any combination thereof.

8. The composition according to claim 2, wherein the ratio of the adduct and the organic material (Z) is from about 1 to about 99 percent by weight of the adduct and from about 99 to about 1 percent by weight of the organic material (Z).

9. The composition according to claim 1, wherein the polyisocyanate comprises a compound having an average of more than one isocyanate group per molecule; and
wherein the polyisocyanate comprises at least one of an aliphatic polyisocyanate, a cycloaliphatic polyisocyanate, a polycycloaliphatic polyisocyanate, an aryl substituted aliphatic polyisocyanate, an aromatic polyisocyanate, heterocyclic polyisocyanate, and any mixture thereof, prepolymer, or any oligomer thereof.

10. The composition according to claim 9, wherein the polyisocyanate comprises at least one of a polyisocyanate containing urethane group, a polyisocyanate containing carbodiimide group, a polyisocyanate containing allophanate group, a polyisocyanate containing isocyanurate group, a polyisocyanate containing urea group, a polyisocyanate containing biuret group, a polyisocyanate containing acylated urea group, a polyisocyanate containing ester group, and any mixture thereof.

11. The composition according to claim 10, wherein the polyisocyanate comprises at least one of a toluene diisocyanate, a diisocyanatodiphenylmethane, a polyphenyl polymethylene polyisocyanate, an isophorone diisocyanate, a hexamethylene diisocyanate, a hydrogenated diisocyanatodiphenylmethane, and any mixture or any isomeric mixture thereof.

12. The composition according to claim 1, wherein the adduct comprises at least four isocyanate reactive hydrogen atoms per molecule and the ratio of the polyisocyanate to the adduct is from about 0.9:1 to about 1.25:1 equivalents of the isocyanate group in the polyisocyanate per equivalent of isocyanate reactive hydrogen atom per molecule in the adduct.

13. The composition according to claim 1 further comprising a catalyst; and wherein the catalyst comprises an organic salt, an inorganic acid salt, an organometallic derivative, or mixtures thereof.

14. The composition according to claim 13, wherein the catalyst comprises an organic salt of bismuth, tin, iron, antimony, cobalt, thorium, aluminum, zinc, nickel, cerium, molybdenum, vanadium, copper, manganese, zirconium, phosphines, tertiary organic amines, or mixtures thereof; wherein the catalyst comprises an inorganic salt of bismuth, tin, iron, antimony, cobalt, thorium, aluminum, zinc, nickel, cerium, molybdenum, vanadium, copper, manganese, zirconium, phosphines, tertiary organic amines, or mixtures thereof; or wherein the catalyst comprises an organometallic derivative of bismuth, tin, iron, antimony, cobalt, thorium, aluminum, zinc, nickel, cerium, molybdenum, vanadium, copper, manganese, zirconium, phosphines, tertiary organic amines, or mixtures thereof.

15. A thermoset polyurethane comprising at least one cis, trans-1,3- and -1,4-cyclohexanedimethylether moiety.

16. An article comprising the thermoset polyurethane of claim 15; and
wherein the article is at least one of a casting, a molding, a coating, a structural foam, a flexible foam, a rigid foam, and an insulation structure.

17. The article according to claim 16, wherein the article is a polyisocyanurate foam; and wherein the polyisocyanurate foam comprises a polyisocyanurate-polyurethane structure or a polyisocyanurate-polyurethane-polyurea structure.
